(19) United States
(12) Patent Application Publication
(10) Pub. No.: US 2006/0209651 A1
(43) Pub. Date: Sep. 21, 2006

(54) Optical information recording apparatus, apparatus and method for setting write strategy, and computer program therefor

(75) Inventors: Harutaka Sekiya, Yokohama-si (JP); Shin Kagami, Yokohama-si (JP); Toshiaki Suzuki, Yokohama-si (JP); Toru Yoshida, Yokohama-si (JP)

Correspondence Address: LEE & MORSE, P.C., 1101 WILSON BOULEVARD, SUITE 2000, ARLINGTON, VA, 22209, US

(73) Assignee: Samsung Electronics Co., Ltd.

(21) Appl. No.: 11/362,521

(22) Filed: Feb. 27, 2006

(30) Foreign Application Priority Data
Feb. 25, 2005 (JP) 2005-051620
Jun. 15, 2005 (JP) 2005-175747

(51) Int. Cl. G11B 7/12

(52) U.S. Cl. 369/47.53

(57) ABSTRACT

An optical information recording apparatus, an apparatus and method for setting a write strategy, and a computer program therefor are provided. In the optical information recording apparatus, a write strategy corresponding to different linear velocities of an optical recording medium is set, and, based on the set write strategy, a write strategy corresponding to an arbitrary linear velocity is determined.

### BACKGROUND OF THE INVENTION

1. Field of the Invention

The present invention relates to an optical information recording apparatus. More particularly, the present invention relates to an optical information recording apparatus for setting a write strategy to record information on an optical recording medium, an apparatus and method for setting a write strategy, and a computer program therefor.

2. Description of the Related Art

As internet use has increased rapidly thanks to the recent development of the information communication technologies, a huge amount of information is now exchanged over networks. In this environment, in the field of an information recording apparatus, write-once-read-many optical disks, e.g., a CD-R, and rewritable optical disks, e.g., a CD-RW, have been highlighted as recording media. Also, as wavelengths of light sources, e.g., semiconductor lasers, used to optically record information have been shortened, the spot diameter of a high numerical aperture (NA) object lens having a high NA has also been being shortened, and thin substrates have been employed recently, high capacity optical disks, such as a DVD-R, DVD-RW, and DVD-RAM, are now widely used.

Recording information on a CD-R and the like is performed by converting recording information received from a personal computer (PC) into an eight-to-fourteen modulation (EFM) signal. However, due to the difference in compositions in dye recording layers forming the optical disk, thermal storage or cooling speed of the optical disk may be insufficient and pits may be formed with defects. As a result, though the EFM signal is to be faithfully recorded, a desired pit or land cannot be formed.

Accordingly, a method of maintaining a good write quality by setting a recording parameter (hereinafter referred to as a write strategy) unique to individual optical disk to be used, with respect to a write waveform that is a reference, has been employed.

Widely used representative write strategies include varying the ratio of pits and lands, adding an additional pulse to the front end of a writing pulse, changing a rising or falling position of a pulse with a combination of a pit and a land, and dividing a write pulse into multiple pulses. More specifically, setting of these write strategies are performed by forming pits and lands in a test recording area of an optical recording medium with a standard write strategy (also referred to as a reference write strategy) and adjusting a pulse width or recording power according to the recording quality of the area.

However, the write strategy also depends on the linear velocity as well as the dye of the optical disk, phase change material, thickness of a dye film, or the shape of a groove. Accordingly, even in identical optical recording media, if the linear velocity changes, a write strategy corresponding to each linear velocity is needed. To solve this problem, a technology for determining a write strategy by performing a test recording in a test recording area on an outer circumference of an optical recording medium if the linear velocity of the optical recording medium becomes equal to or higher than a predetermined level has been suggested.

However, according to this method, whenever the linear velocity of the optical recording medium becomes equal to or higher than the predetermined level, test recording should be performed in the predetermined test recording area of the optical recording medium and a write strategy should be set according to the result. Accordingly, the processing of this method is complicated. In particular, when the linear velocity changes endlessly with respect to the position of the optical recording medium, as in a constant angular velocity (CAV) method, the implantation is even further complicated.

### SUMMARY OF THE INVENTION

The present invention is therefore directed to wobble detection, which substantially overcomes one or more of the problems due to the limitations and disadvantages of the related art.

It is therefore a feature of an embodiment of the present invention to provide an optical information recording apparatus for setting a write strategy to record information on an optical recording medium, by which the number of required test recordings can be reduced, and an appropriate write strategy corresponding to a variety of linear velocities can be set, an apparatus and method for setting a write strategy, and a computer program therefor.

At least one of the above and other features and advantages may be realized by providing an optical information recording apparatus, in which an optical recording medium is rotated, a light beam is modulated according to data for recording and is applied to a recording area of the optical recording medium, the apparatus including a recording unit recording data for test recording on at least two different test recording parameters in a radial direction of the optical recording medium, a write strategy setting unit setting a write strategy with respect to each of the test recording positions, based on the recording result from the recording unit, and a write strategy determination unit determining a write strategy for an arbitrary position among recording areas of the optical recording medium, by curve fitting in accordance with the write strategies set by the write strategy setting unit.

At least one of the above and other features and advantages may be realized by providing a write strategy setting apparatus, including a test recording unit recording data for test recording on at least two different test recording parameters in a radial direction of an optical recording medium, while rotating the optical recording medium, a write strategy setting unit setting a write strategy with respect to each of the test recording positions, based on the recording result by the recording unit, a write strategy determination unit determining a write strategy for an arbitrary position among recording areas of the optical recording medium by curve fitting based on the write strategies set by the write strategy setting unit, and an output unit outputting the determination result by the write strategy determination unit to an external device.

At least one of the above and other features and advantages may be realized by providing a write strategy setting apparatus provided separately from an external device in which an optical recording medium is rotated and a light beam modulated according to data for recording is applied to a recording area of the optical recording medium, the apparatus including a control signal transmission unit transmitting a control signal to the external device so that data for test recording is recorded on at least two different test recording parameters in a radial direction of the optical recording medium, a write strategy setting unit setting a write strategy with respect to each of the test recording positions, based on the recording result obtained from the external device, and a write strategy determination unit determining a write strategy for an arbitrary position among recording areas of the optical recording medium by curve fitting the write strategies set by the write strategy setting unit.

At least one of the above and other features and advantages may be realized by providing a write strategy setting method, including recording data for test recording on at least two different test recording parameters in a radial direction of an optical recording medium being rotated, setting a write strategy with respect to each of the test recording positions, based on the recording result, and determining a write strategy for an arbitrary position among recording areas of the optical recording medium by curve fitting the set write strategies.

At least one of the above and other features and advantages may be realized by providing a computer readable recording medium having embodied thereon a computer program for a write strategy setting method, wherein the method includes recording data for test recording on at least two different test recording positions in a radial direction of an optical recording medium being rotated, setting a write strategy with respect to each of the test recording positions based on the recording result, and determining a write strategy for an arbitrary position among recording areas of the optical recording medium by curve fitting the set write strategies.

The optical recording medium may b e operated at a constant angular velocity or at a changing angular velocity step by step in each of areas that are divided in the radial direction between an inner circumference and an outer circumference of the optical recording medium.

The curve fitting may include linear interpolating or extrapolating.

The different test recording parameters are at least one of two different recording speeds and two different test recording positions.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates the relation between a linear velocity and parameters of a write strategy;

FIG. 2 illustrates a block diagram of a structure of an optical information recording apparatus according to an embodiment of the present invention;

FIG. 3 illustrates a write strategy for a CD-R according to an embodiment of the present invention;

FIG. 4 illustrates a flowchart for an operation of an optical information recording apparatus according to an embodiment of the present invention;

FIG. 5 illustrates the effects of a length change to other pits when the length of 3T or 6T is changed;

FIG. 6 illustrates a write strategy for a CD-R (1T) according to an embodiment of the present invention;

FIG. 7 illustrates a write strategy for a CD-R (2T) according to an embodiment of the present invention; and

FIG. 8 illustrates a write strategy for a DVD±R according to an embodiment of the present invention.

### DETAILED DESCRIPTION OF THE INVENTION

Japanese Patent Application Nos. 2005-051620, filed on Feb. 25, 2005, and 2005-175747, filed on Jun. 15, 2005, in the Japanese Intellectual Property Office, and entitled: “Optical Information Recording Apparatus, Apparatus and Method for Setting Write Strategy, and Computer Program Therefor,” are incorporated by reference herein in their entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art.

Recording of a signal on optical recording medium is performed by irradiating a laser beam emitted from an optical pickup to a dye recording layer of the optical recording medium, and heating and transforming the dye recording layer by the energy of the irradiated laser. Accordingly, the power of the laser beam emitted from the optical pickup and the irradiation time (write pulse width) are important factors to determine the quality of data recording.

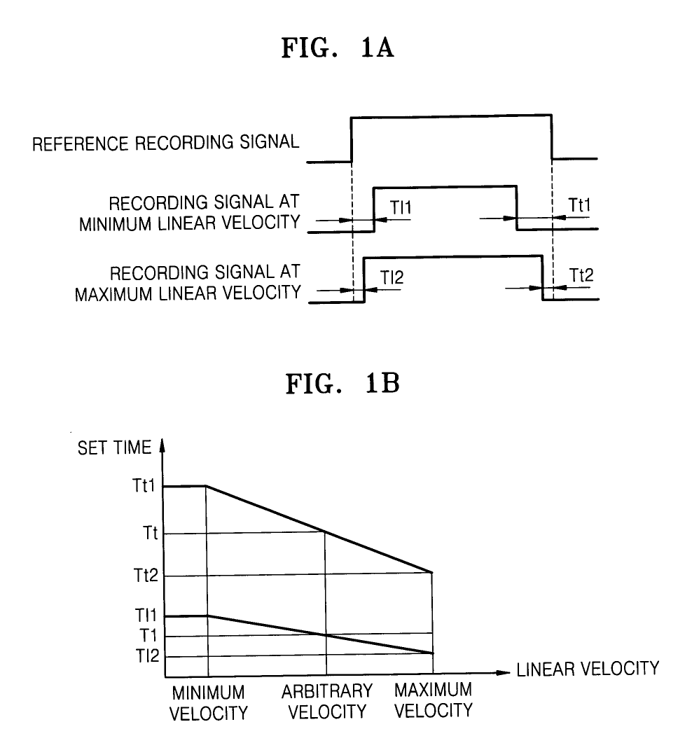

In particular, when a signal is recorded on an optical recording medium, how to set the irradiation time (write pulse width) of a laser beam according to change of the linear velocity of the optical recording medium is an important factor. FIG. 1A illustrates the relation between signals (referred to as a reference recording signal in FIG. 1A) desired to be recorded, such as 3T and 4T that are determined by standards, and the write strategies at the maximum linear velocity and at the minimum linear velocity. Referring to FIG. 1A, Tl1 is an adjustment value of the front edge of the write strategy (write pulse) at the minimum linear velocity, Tl2 is an adjustment value of the front edge of the write strategy (write pulse) at the maximum linear velocity, Tt1 is an adjustment value of the back edge of the write strategy (write pulse) at the minimum linear velocity, and Tt2 is an adjustment value of the back edge of the write strategy (write pulse) at the maximum linear velocity.

As shown in FIG. 1A, in order to make a standardized recording signal regardless of the linear velocity when a signal is recorded, the relationships between Tl1 and Tl2 and Ttl and Tt2 at the minimum linear velocity and the maximum linear velocity, should be Tl1>Tl2 and Tt1>Tt2.

When these relationships are analyzed from the minimum linear velocity to the maximum linear velocity, the relationships between the linear velocity and the set times, such as Tl1, Tl2, Tt1, and Tt2 change along the straight line connecting Tl1 and Tl2 and the straight line connecting Tt1 and Tt2 with the changing linear velocity as shown in FIG. 1B.

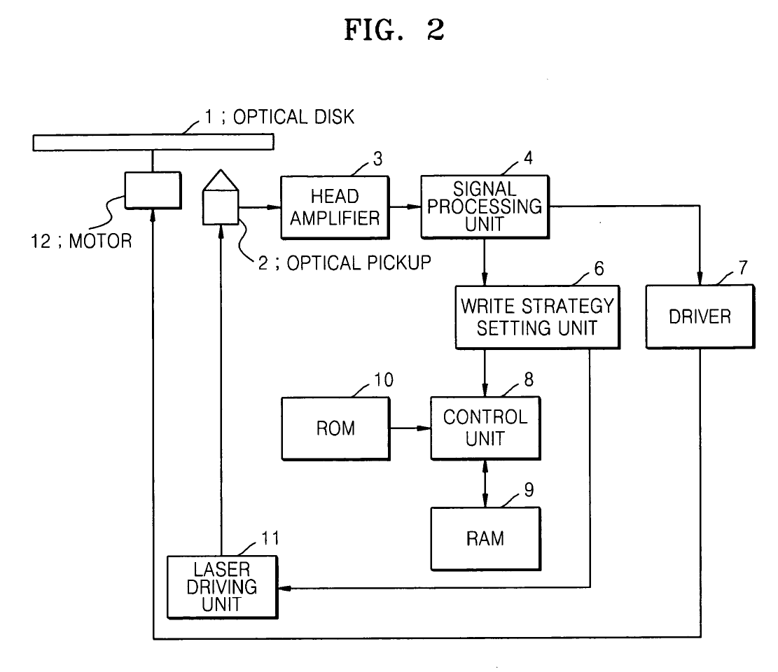

The present invention is based on the relation between the linear velocity and a setting time. An optical information recording apparatus according to an embodiment of the present invention will now be explained with reference to FIG. 2.

The optical information recording apparatus is to record information on an optical disk 1. The optical information recording apparatus according to the first embodiment of the present invention may include an optical pickup 2, a head amplifier 3, a signal processing unit 4, a write strategy setting unit 6, a driver 7, a control unit (write strategy determination unit) 8, a RAM 9, a ROM 10, a laser driving unit (recording unit) 11, and a motor 12.

The optical disk 1 may be a recording medium capable of recording, reproducing, and deleting information in response to an optical signal, and includes, e.g., a CD-R, a CD-RW, a DVD-R, a DVD±RW, and a DVD-RAM. The optical pickup 2 may include a light source, e.g., a laser diode (not shown) to irradiate the optical disk 1 and a detector (not shown) to receive light reflected back from the optical disk 1. A pit has a lower reflectivity than a land. The detector may be a four-division or two-division photo detector (PD) with four divided regions, A, B, C, and D, which converts light into an electrical signal. The optical pickup 2 may also include any known components for enhancing the performance of the optical pickup. For example, the optical pickup 2 may include optical components such as a collimator lens, an object lens driven by a focus actuator or a tracking actuator, a polarized beam splitter, a cylindrical lens and a front monitor diode monitoring a laser output when information is recorded or reproduced.

The head amplifier 3 may receive an output of the optical pickup 2 indicative of light reflected from the optical disk 1, calculate the amount of the reflected light based on the detected reflected light, and generate a radio frequency (RF) signal indicating the total sum of the reflected light amounts of respective regions of the four-division PD. The head amplifier 3 may also generate a focus error (FE) signal indicating mis-focus of a laser irradiated by the optical pickup 2, by, for example, an astigmatism method. Furthermore, the head amplifier 3 may generate a tracking error (TE) signal indicating track distraction of a laser irradiated by the optical pickup 2, by, for example, a push-pull method.

The signal processing unit 4 may generate an EFM signal from the RF signal generated by the head amplifier 3. The EFM signal must have no two consecutive ones. Thus, the minimum spacing between two ones will be two zeros, i.e., 3T pit/land, where T is one clock period, and the maximum spacing between two ones will be ten zeros, i.e., 11T pit/land. The signal processing unit 4 may include a phase locked loop (PLL) circuit (not shown) and may control the rotations of the optical disk 1.

The write strategy setting unit 6 may compare the EFM signal extracted from information recorded on a reference write strategy by the signal processing unit 4 with theoretical lengths of each pit and land, and obtains a differential value (hereinafter referred to as a deviation value) between the two values. Then, the write strategy setting unit 6 may set an appropriate write strategy from the deviation value and probabilities of presence of each pit and land.

The driver 7 may amplify a servo signal generated in the head amplifier 3 and the signal processing unit 4, and provide the amplified servo signal to a focus actuator, a tracking actuator, a carriage motor or a spindle motor.

The control unit 8 may control the entire optical information recording apparatus according to a control program. In particular, in the present embodiment, the control unit 8 may control setting of a write strategy when information is recorded on the optical disk 1.

The RAM 9 is a rewritable memory device, and may store write strategies set to different linear velocities and a write strategy corresponding to each linear velocity determined based on the write strategies.

The ROM 10 is a memory device that is not rewritable, and may store a control program to control the entire optical information recording apparatus, reference write strategies, the theoretical length of each pit and land, or the probability of presence in the combination of each pit and land.

The laser driving unit 11 may generate a pulse signal for driving a laser diode based on the write strategy input from the write strategy setting unit 6, and provide the signal to the optical pickup 2. The motor 12 may be a spindle motor including a DC motor rotating the optical disk 1.

<First Embodiment>

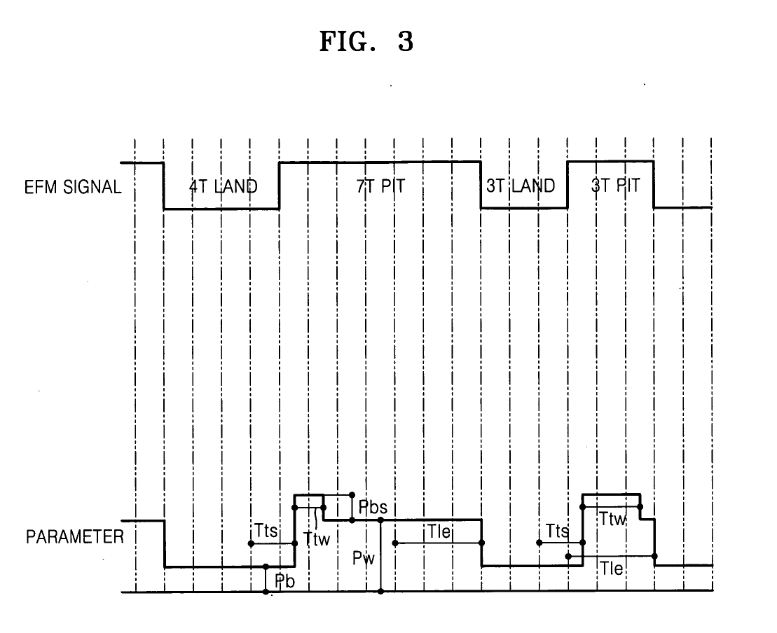

A first embodiment of setting a write strategy of the present invention will now be explained with an example where a CD-R is used as a recording medium and information is recorded using a CAV method. Here, a power type write strategy, as shown in FIG. 3, is used.

As illustrated in FIG. 3, the power type write strategy includes a top pulse and a last pulse. The top pulse and the last pulse may be defined by parameters Tts, Ttw, Tle, Pw, Pbs and Pb. Tts is the start edge of a top pulse at 1T before a rising edge of an EFM signal. Ttw is the width of the top pulse. Tle is the end edge of a last pulse at 3T before a falling edge of an EFM signal. Pw is a recording power. Pbs is a boost power. Pb is a bias power.

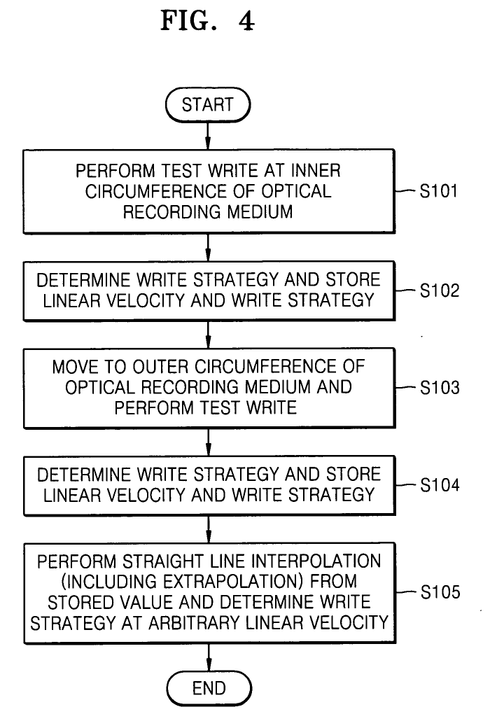

Among the parameters, Tts and Tle are closely related to linear velocity. A method of setting Tts and Tle according to each linear velocity according to the first embodiment will now be explained with reference to FIG. 4.

If a CD-R is placed as the optical disk 1 in the optical information recording apparatus and the apparatus enters in a recording mode, the control unit 8 may move the optical pickup 2 to a test recording area located on an inner circumference of the CD-R, and record information according to a write strategy that is obtained by lengthening/shortening predetermined pits and lands of a reference write strategy by a multiple of a minimum resolution in operation 101. When recording of the information is finished, the control unit 8 may again move the optical pickup 2 to the front of the recorded information and read the information. An LSI chip may set a write strategy and operate based on a predetermined clock. Accordingly, it is impossible to continuously change a write strategy in an analog fashion. Thus, a change in write strategy is made in a discrete fashion, with one clock being a minimum change quantity. Here, the minimum change quantity is referred to as a minimum resolution.

The signal optically read by the optical pickup 2 may be input to the signal processing unit 4 and converted into an EFM signal. The converted EFM signal may be input to the write strategy setting unit 6. The write strategy setting unit 6 may compare the EFM signal with theoretical lengths of each pit and land from the ROM 10, and calculate the differential value (deviation value). The deviation value may include the extension and reduction quantities unique to each pit and land, and the effect by other pits and lands. Accordingly, by using the presence probability by a combination of each pit and land, the effect degree at a time when the length of another pit or land is changed, may be obtained. By using the deviation value and the effect degree, the extension and reduction quantity of each pit and land may be calculated.

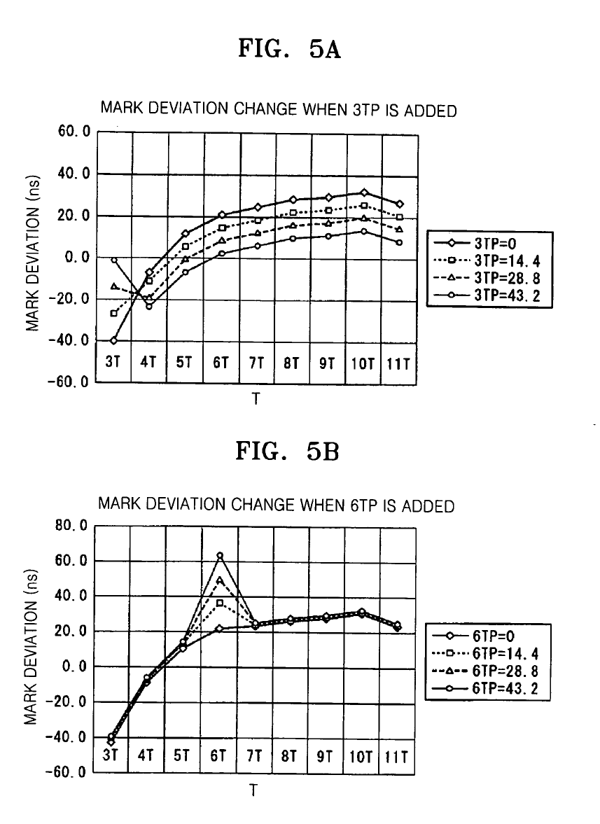

Referring to FIG. 5, a method of calculating the extension and reduction quantity unique to each pit and land will now be explained in more detail.

The pits and lands of an EFM signal are formed so that the sum of the lengths of pits can be the same as the sum of the lengths of lands. Accordingly, e.g., if the length of a land is extended, the balance between the distribution of pits and lands is broken. To compensate for this, a predetermined changed land may be inserted. As a result, the length of the entire lands is shortened again. In an actual reproduced waveform (RF signal), this phenomenon changes the slice level, i.e., threshold level.

More specifically, FIG. 5A shows the change in the lengths of other lands, i.e., lands from 4T to 11T, when a 3T land in an EFM is extended by ΔT (3T). In FIG. 5A, deviation with respect to a theoretical length is indicated on the vertical axis, and 3T to 11T are indicated on the horizontal axis indicates. Curves of FIG. 5A show deviation changes when the deviation of the 3T land is 0, 14.4 ns, 28.8 ns, and 43.2 ns, respectively.

If the probability of a 3T land being in an EFM signal is 33%, a relationship between the changed quantity (ΔT (3T)) of a 3T land and the changed quantities (ΔT (4−11T)) of 4T to 11T lands may be given by:
ΔT(3T)×0.33=ΔT(4−11T)×(1−0.33) or
ΔT(4−11T)=ΔT(3T)×0.33/(1−0.33) . . . (1)

Referring to equation 1, the changed quantity from 4T to 11T lands is approximately half the changed quantity of the 3T land. This is supported by the result of actual measuring illustrated in FIG. 5A. In addition, as illustrated in FIG. 5B, when a 6T land having a low probability of being in the EFM signal is changed in the same manner, the effect of this change to the lengths of other pits or lands is very small.

Accordingly, if the probability of a combination of each pit and land being in an EFM signal is used, the effect degree with respect to the length of other pits or lands when the length of a predetermined pit or land is changed can be identified.

More specifically, when a recording signal is reproduced, the recording lengths at all combinations of pits and lands may be measured, and the measured results may be stored in the RAM 9. A first deviation value between the recording length when information is recorded using a reference write strategy stored in the RAM 9, and the theoretical length at all combinations of pits and lands stored in the ROM 10 may be calculated. A second deviation value between the recording length when information is recorded using a write strategy obtained by lengthening/shortening predetermined pits and lands of a reference write strategy by a multiple of a minimum resolution, and the theoretical length at all combinations of pits and lands stored in the ROM 10 may be calculated. Then, the deviation value between the first deviation value and the second deviation value may be calculated. In particular, if the extension and reduction quantity of each combination of lands from 3T to 5T lands, and pits from 3T to 5T pits of the reference write strategy, is a multiple of the minimum resolution, then the deviation value may be divided by the multiple value, and the result is obtained as a deviation value with respect to the minimum resolution.

In order to calculate the extension and reduction quantity unique to each pit and land from the calculated deviation value, the probability of the presence of a combination of each pit and land explained above is used.

For example, the extension and reduction quantity by a combination of a 3T pit and a 3T land is obtained by removing the effect by changes in other pits and lands from the deviation value of the combination of a 3T pit and a 3T land. Accordingly, assuming that the unique extension and reduction quantities at combinations of a 3T pit and a 3T land, a 4T land, and a 5T land are ΔT(3, 3), ΔT(4, 3), and ΔT(5, 3), respectively, and the probabilities of the presence of the combinations are R(3, 3), R(4, 3), and R(5, 3), respectively, and the deviation value of a 3T pit and a 3T land is A, there a relationship may be defined as the follows:
ΔT(3, 3)−ΔT(4, 3)×R(4, 3)/(1−R(4, 3))
ΔT(5, 3)×R(5, 3)/(1−R(5, 3))=A . . . (2)

Meanwhile, in a combination including a 6T pit or a 6T land, a predetermined deviation value exists even though a 6T pit or land does not change. This deviation value is a collective effect by the changes in the length of each combination of lands from 3T to 5T lands and pits from 3T to 5T pits.

Accordingly, for example, assuming that the deviation value of a 3T pit and a 6T land is Z, Z is expressed as the following equation 3 and if equation 3 is inserted into equation 2, equation 4 is derived. In the same manner, the extension and reduction quantity unique to the combination of each pit and land can be obtained from the probability of the presence of the combination.
Z=ΔT(3, 3)×R(3, 3)/(1−R(3, 3))
+ΔT(4, 3)×R(4, 3)/(1−R(4, 3))
+ΔT(5, 3)×R(5, 3)/(1−R(5, 3)) . . . (3)
ΔT(3, 3)=(Z+A)(1−R(3, 3)) . . . (4)

If the extension and reduction quantity unique to the combination of each pit and land is obtained, Tts and Tle that minimize this unique extension and reduction quantity may be obtained through respective calculations. The obtained Tts and Tle may be stored together with corresponding linear velocities in the RAM 9 in operation 102.

Then, the control unit 8 may move the optical pickup 2 to a test recording area located at an outer circumference of the CR-R and record information according to a write strategy obtained by lengthening/shortening predetermined pits and lands of a reference write strategy by a multiple of a minimum resolution in operation 103.

Then, in the same manner as in operation 102, Tts and Tle that minimize the unique extension and reduction quantity unique to the combination of each pit and land may be obtained through respective calculations, and the result may be stored together with linear velocities in operation 104.

When the operations from 101 through 104 are finished, the write strategy setting unit 6 may read Tts and Tle corresponding to other linear velocities from the RAM 9 through the control unit 8, and may obtain Tts and Tle corresponding to each linear velocity through straight line interpolation using the relation. Thus obtained Tts and Tle may be paired with corresponding linear velocities and stored in the RAM 9 in operation 105.

By setting optimal Tts and Tle with respect to the changed linear velocities when the linear velocity changes, the recording quality can be maintained according to the present embodiment.

In the present embodiment, recording operations with different linear velocities according to the CAV recording method may be performed in the test recording areas at the inner circumference and the outer circumference. However, by varying the linear velocity in the test recording area of an inner circumference, a recording operation can be performed. Also, the different linear velocities are not limited to the minimum linear velocity and the maximum linear velocity. Recording may be performed with at least two or more different linear velocities, and then through interpolation or extrapolation, a write strategy at other linear velocities can be obtained based on the data obtained from the recording operations. Thus, generally, curve fitting may be used to set a write strategy at other linear velocities.

Also, the present embodiment can be applied, for example, to an optical recording medium on which the space is divided into a plurality of areas and different angular velocities are set to respective areas. That is, in an area with angular velocity A, information is recorded with a write strategy corresponding to each linear velocity obtained by the method of the present embodiment, while in other areas with angular velocity B, a recording operation can be performed by obtaining a write strategy corresponding to each linear velocity according to the method of the present embodiment.

Also, in the present embodiment as discussed above, the optical recording medium is rotated with a constant angular velocity by a CAV method. However, the present invention is not limited to this, and can be applied to other rotation control methods (for example, a zone constant linear velocity (ZCLV) method and a partial constant angular velocity (PCAV) method) by which the optical recording medium is rotated with a recording speed changing between inner circumferences and outer circumferences changes.

In the ZCLV method, a disk is divided from an inner circumference into a plurality of zones, and a linear velocity is maintained to be constant in one zone. In the PCAV method, an inner circumference of a disk is accessed through a CAV method, while an outer circumference is accessed through a constant linear velocity (CLV) method.

<Second Embodiment>

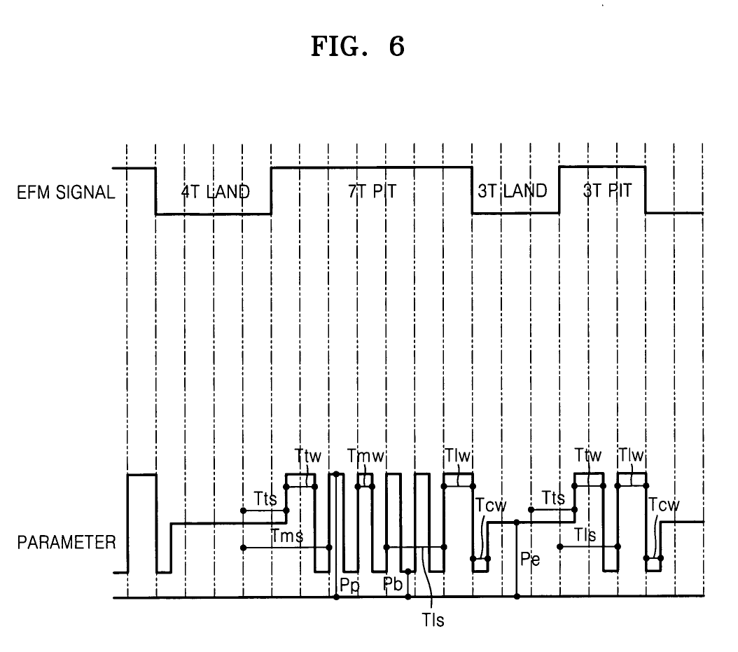

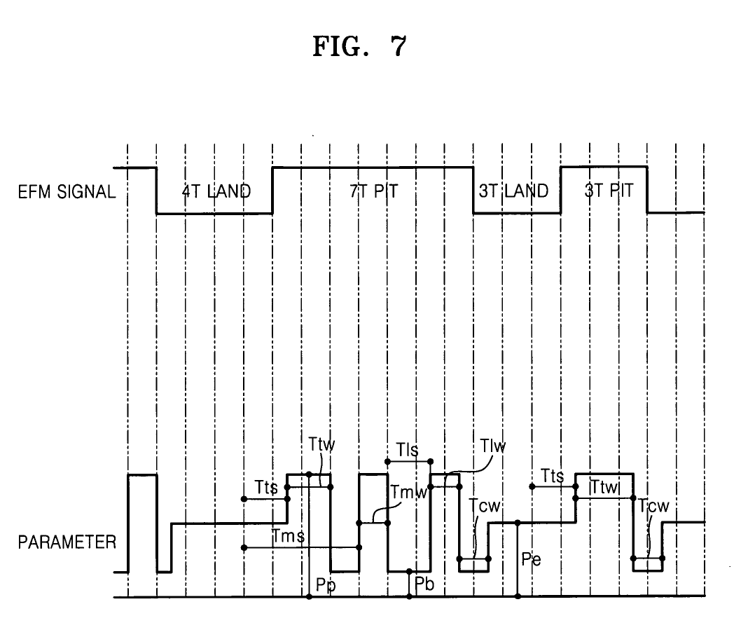

A second embodiment of the present invention will now be explained with an example where a CD-RW is used as a recording medium and is recorded using a CAV method. A method of setting a write strategy according to the second embodiment with respect to FIGS. 6 and 7 will now be explained.

For the CD-RW, a multipulse write strategy (1T) is used for a recording speed equal to or less than a 16 times (16×) speed and a multipulse write strategy (2T) is used for a recording speed higher than a 16× speed are used.

As illustrated in FIG. 6, the multipulse write strategy (1T) includes one recording pulse with an interval of 1T, and includes a top pulse and a last pulse. The top pulse and last pulse are defined by parameters Tts, Ttw, Tms, Tmw, Tls, Tlw, Tcw, Pp, Pe and Pb. Tts is the start edge of a top pulse at 1T before a rising edge of an EFM signal. Ttw is the width of a top pulse. Tms is the start edge of a multi pulse at 1T before a rising edge of the EFM signal. Tmw is the width of a multi pulse. Tls is the end edge of a last pulse from a point, 1T before a falling edge of an EFM signal. Tlw is the width of a last pulse. Tcw is the width of a cooling pulse. Pp is a peak power. Pe is an erasing power. Pb is a bias power.

The multipulse write strategy (2T) includes one recording pulse with an interval of 2T as shown in FIG. 7, and has the same structure and parameters as those of the multi pulsed type (1T).

For the multipulse write strategy (1T) or (2T), Tts, Tlw, and Tcw, in particular, among the parameters defining the write strategy are closely related to the linear velocity. Accordingly, with respect to these parameters, adjustment corresponding to the linear velocity is needed. A method of setting these parameters according to the linear velocity is performed as shown in FIG. 4 explained above in relation to the first embodiment.

Accordingly, according to the present embodiment, even when the linear velocity changes as in the CAV method when a recording operation is performed on the CR-RW as a recording medium, by setting optimal Tts, Tlw, and Tcw according to the linear velocity at the time of recording, the quality of recording can be maintained.

<Third Embodiment>

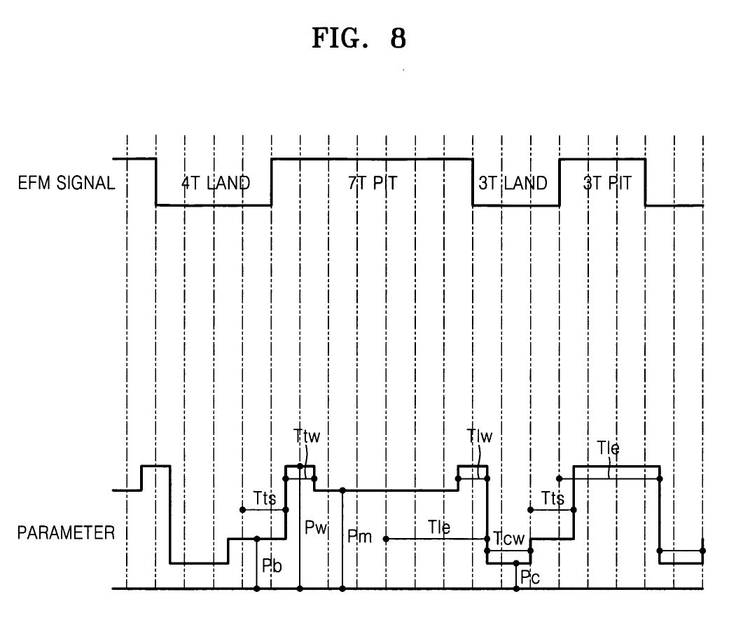

A third embodiment of the present invention will now be explained with reference to FIG. 8, where a DVD±R is used as a recording medium and recorded using to a CAV method. A method of setting a write strategy according to the third embodiment will now be explained. In the DVD±R, a castle write strategy is used.

As illustrated in FIG. 8, the write strategy of the castle type includes a top pulse and a last pulse. The top pulse and last pulse are defined by parameters, such as Tts, Ttw, Tle, Tlw, Pw and Pb. Tts is the start edge of a top pulse at 1T before a rising edge of an EFM signal. Ttw is the width of a top pulse. Tle is the end edge of a last pulse at 3T before a rising edge of an EFM signal. Tlw is the width of the last pulse. Pw is a write power. Pb is a bias power.

For the castle write strategy, Tts and Tle are closely related to the linear velocity. Accordingly, with respect to these parameters, adjustment in accordance with the linear velocity is needed. Furthermore, a method of setting these parameters according to the linear velocity may be performed as shown in FIG. 4 explained above in relation to the first embodiment.

Accordingly, according to the present embodiment, even when the linear velocity changes as in the CAV method when a recording operation is performed on the DVD±R as a recording medium, by setting optimal Tts, Tlw, and Tle according to the linear velocity at the time of recording, the quality of recording can be maintained.

In the first through third embodiments, methods of setting a write strategy according to the present invention are applied to the optical information recording apparatuses are explained. However, a write strategy setting apparatus to which a write strategy setting method of the present invention are applied, may be provided separately from an optical information recording apparatus.

That is, the write strategy setting apparatus records data for test recording on at least two different test recording positions in the radius direction of an optical recording medium. The write strategy setting apparatus sets an optimal write strategy with respect to each test recording position based on the recording result. At the same time, the write strategy setting apparatus performs interpolation or extrapolation based on each of the set write strategies and determines a write strategy with respect an arbitrary position among recording areas of the optical recording medium. Then, the write strategy setting apparatus outputs the determination result to an optical information recording apparatus with respect to an optical recording medium.

Also, in another embodiment, a control signal for recording data for test recording on at least two different test recording positions in the radius direction of an optical recording medium is transmitted, and based on the recording result obtained from an optical information recording apparatus, an optimal write strategy is set with respect to each test recording position. Based on the each write strategy, interpolation or extrapolation is performed so that a write strategy with respect an arbitrary position among recording areas of the optical recording medium can be determined.

Optimum embodiments have been explained above and are shown. However, the present invention is not limited to the preferred embodiment described above, and it is apparent that variations and modifications by those skilled in the art can be effected within the spirit and scope of the present invention defined in the appended claims. For example, in the present embodiments methods by which write strategies are set at two points having different linear velocities and through straight line interpolation of the write strategies, write strategies corresponding to other linear velocities are determined are explained. However, write strategies at more than two points may be set and through straight line interpolation with close linear velocities, write strategies for other linear velocities may also be determined.

Also, in the present embodiments, methods, by which parameters closely related to the linear velocity among parameters defining a write strategy are adjusted appropriately according to the linear velocity are explained. However, according to the relation between each parameter and a linear velocity, the adjustment frequency of the parameter may be changed or an adjustment priority may be given and then adjustment may be performed according to the adjustment priority. Also, a combination of these methods may be performed.

According to the present invention as described above, even when the linear velocity changes according to the recording position of an optical recording medium as in the CAV method, the frequency of test recordings to determine a write strategy can be minimized such that an optimal write strategy can be set.

Exemplary embodiments of the present invention have been disclosed herein, and although specific terms are employed, they are used and are to be interpreted in a generic and descriptive sense only and not for purpose of limitation. For example, while EFM has been described above, the write strategy settings of the present invention may be employed with other modulation techniques, such as EFM+. Accordingly, it will be understood by those of ordinary skill in the art that various changes in form and details may be made without departing from the spirit and scope of the present invention as set forth in the following claims.

What is claimed is:

1. An optical information recording apparatus, in which an optical recording medium is rotated, a light beam is modulated according to data for recording and is applied to a recording area of the optical recording medium, the apparatus comprising:
a recording unit recording data for test recording on at least two different test recording parameters in a radial direction of the optical recording medium;
a write strategy setting unit setting a write strategy with respect to each of the test recording positions, based on the recording result from the recording unit; and
a write strategy determination unit determining a write strategy for an arbitrary position among recording areas of the optical recording medium, by curve fitting in accordance with the write strategies set by the write strategy setting unit.

2. The optical information recording apparatus as claimed in claim 1, wherein the optical recording medium is operated at a constant angular velocity or at a changing angular velocity step by step in each of areas that are divided in the radial direction between an inner circumference and an outer circumference of the optical recording medium.

3. The optical information recording apparatus as claimed in claim 1, wherein the optical recording medium is operated at a changing recording speed between an inner circumference and an outer circumference of the optical recording medium.

4. The optical information recording apparatus as claimed in claim 1, wherein the curve fitting includes linear interpolating or extrapolating.

5. The optical information recording apparatus as claimed in claim 1, wherein the different test recording parameters are at least one of two different recording speeds and two different test recording positions.

6. A write strategy setting apparatus, comprising:
a test recording unit recording data for test recording on at least two different test recording parameters in a radial direction of an optical recording medium, while rotating the optical recording medium;
a write strategy setting unit setting a write strategy with respect to each of the test recording positions, based on the recording result by the recording unit;
a write strategy determination unit determining a write strategy for an arbitrary position among recording areas of the optical recording medium by curve fitting based on the write strategies set by the write strategy setting unit; and
an output unit outputting the determination result by the write strategy determination unit to an external device.

7. The write strategy setting apparatus as claimed in claim 6, wherein the optical recording medium is operated at a constant angular velocity or at a changing angular velocity step by step in each of areas that are divided in the radial direction between an inner circumference and an outer circumference of the optical recording medium.

8. The write strategy setting apparatus as claimed in claim 6, wherein the optical recording medium is operated at a changing recording speed between an inner circumference and an outer circumference of the optical recording medium.

9. The write strategy setting apparatus as claimed in claim 6, wherein the curve fitting includes linear interpolating or extrapolating.

10. The write strategy setting apparatus as claimed in claim 6, wherein the different test recording parameters are at least one of two different recording speeds and two different test recording positions.

11. A write strategy setting apparatus provided separately from an external device in which an optical recording medium is rotated and a light beam modulated according to data for recording is applied to a recording area of the optical recording medium, the apparatus comprising:
a control signal transmission unit transmitting a control signal to the external device so that data for test recording is recorded on at least two different test recording parameters in a radial direction of the optical recording medium;
a write strategy setting unit setting a write strategy with respect to each of the test recording positions, based on the recording result obtained from the external device; and
a write strategy determination unit determining a write strategy for an arbitrary position among recording areas of the optical recording medium by curve fitting the write strategies set by the write strategy setting unit.

12. The write strategy setting apparatus as claimed in claim 11, wherein the optical recording medium is operated at a constant angular velocity or at a changing angular velocity step by step in each of areas that are divided in the radial direction between an inner circumference and an outer circumference of the optical recording medium.

13. The write strategy setting apparatus as claimed in claim 11, wherein the optical recording medium is operated at a changing recording speed between an inner circumference and an outer circumference of the optical recording medium.

14. The write strategy setting apparatus as claimed in claim 11, wherein the curve fitting includes linear interpolating or extrapolating.

15. The write strategy setting apparatus as claimed in claim 11, wherein the different test recording parameters are at least one of two different recording speeds and two different test recording positions.

16. A write strategy setting method, comprising:
recording data for test recording on at least two different test recording parameters in a radial direction of an optical recording medium being rotated;
setting a write strategy with respect to each of the test recording positions, based on the recording result; and
determining a write strategy for an arbitrary position among recording areas of the optical recording medium by curve fitting the set write strategies.

17. The write strategy setting method as claimed in claim 16, wherein the optical recording medium is operated at a constant angular velocity or at a changing angular velocity step by step in each of areas that are divided in the radial direction between an inner circumference and an outer circumference of the optical recording medium.

18. The write strategy setting method as claimed in claim 16, wherein the optical recording medium is operated at a changing recording speed between an inner circumference and an outer circumference of the optical recording medium.

19. The write strategy setting method as claimed in claim 16, wherein the curve fitting includes linear interpolating or extrapolating.

20. The write strategy setting method as claimed in claim 16, wherein the different test recording parameters are at least one of two different recording speeds and two different test recording positions.

21. A computer readable recording medium having embodied thereon a computer program for a write strategy setting method, wherein the method comprises:
recording data for test recording on at least two different test recording positions in a radial direction of an optical recording medium being rotated;
setting a write strategy with respect to each of the test recording positions based on the recording result; and
determining a write strategy for an arbitrary position among recording areas of the optical recording medium by curve fitting the set write strategies.

22. The computer readable recording medium as claimed in claim 21, wherein the optical recording medium is operated at a constant angular velocity or at a changing angular velocity step by step in each of areas that are divided in the radial direction between an inner circumference and an outer circumference of the optical recording medium.

23. The computer readable recording medium as claimed in claim 21, wherein the optical recording medium is operated at a changing recording speed between an inner circumference and an outer circumference of the optical recording medium.

24. The computer readable recording medium as claimed in claim 21, wherein the curve fitting includes linear interpolating or extrapolating.

25. The computer readable recording medium as claimed in claim 21, wherein the different test recording parameters are at least one of two different recording speeds and two different test recording positions.
